(19) United States
(12) Patent Application Publication
(10) Pub. No.: US 2008/0163641 A1
(43) Pub. Date: Jul. 10, 2008

(54) ENHANCED AESTHETICS FOR WATER DISPENSING ILLUMINATION

(75) Inventor: ALAN JOSEPH MITCHELL, EVANSVILLE, IN (US)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 11/733,803

(22) Filed: Apr. 11, 2007

Related U.S. Application Data
(60) Provisional application No. 60/882,275, filed on Dec. 28, 2006.

(51) Int. Cl. B67D 5/62; F21S 8/00; B65D 5/66

(52) U.S. Cl. 62/389; 222/113; 239/18; 239/20

(57) ABSTRACT

A water dispenser including a light source that shines into a column of water produced by a nozzle is disclosed. The nozzle may be opaque, clear or semi-transparent. The water dispenser may be located in a household faucet, a refrigerator or any other appliance. The light source may vary in color to indicate either a consumer preference or a change in condition. The color selected may be controlled by a processor that is operatively connected to a display and/or one or more sensors. When in use, water is run through the nozzle to form a column. The light source shines into the column of water and may change color to indicate a preference or a change in condition.

### CROSS-REFERENCE TO RELATED APPLICATION

This application claims the benefit of U.S. provisional application Ser. No. 60/882,275, filed Dec. 28, 2006, which is incorporated herein in its entirety.

### BACKGROUND OF THE INVENTION

The present invention relates generally to a water dispenser. The water dispenser may be included in a household water faucet or within a household refrigerator. In particular, the water dispenser preferably includes a light source where the light shines into a stream of water or a column which is produced by the water dispenser. In this manner, the water column appears to glow from within.

Currently, water dispensers for use in common household applications dispense clear or white (aerated) streams of water. Using any of these dispensers at night, or in the dark, could cause unnecessary spills or wasted water. Therefore, it is desirable to provide a water dispenser that illuminates the column or stream of water being dispensed to minimize the amount of wasted water.

Consumers who have purchased a refrigerator with a built-in water dispenser frequently use the water dispenser. Typically, the water dispenser is provided with a light source above the water dispensing tube that illuminates the entire area where the consumer places a glass to be filled. The general area is illuminated so that the consumer can see where to put the container to be filled with water. The water column itself is not illuminated. Since the typical water column produced by a water dispenser in a refrigerator is not aerated, the water column appears clear. Illuminating the entire area where the consumer typically places the glass makes the clear water column difficult to see. This may have the unfortunate result of causing spills or unnecessarily wasting water. Therefore, it is desirable to illuminate the water column itself instead of the general area of the dispenser and highlight where the consumer should place the glass or container to be filled with water.

Refrigerators with ice makers and/or water dispensers often have water filters to assist in purifying water. Many household water supply systems have similar filtration systems. The water filters in these systems require periodic replacement. To assist in maintaining the refrigerator, it would be beneficial if the refrigerator could tell the consumer when to replace the water filter. It is therefore desirable to have a system that alerts the consumer to change the water filter at a location frequently used by the consumer.

Leaks may also occur in water supply systems. Unfortunately, leaks are often difficult to detect. Unless the leak is relatively large, it may go on for some time before being addressed. It is desirable to have a system that can notify a consumer of a leak in their system and to have the notification occur in a location that is convenient for the consumer.

The water supplied may also vary in temperature. Unfortunately, many of today's faucets have a single lever or knob that is used to control the temperature of the water being dispensed. Because extremely hot water can be dangerous, it would be desirable if a second indicator could be used to tell the consumer whether the water being dispensed is hot or cold.

What is needed is an improved appliance or faucet for addressing these problems.

### BRIEF SUMMARY OF THE INVENTION

Therefore, it is a primary object, feature or advantage of the present invention to improve upon the state of the art.

It is a further feature of the present invention to provide a water dispensing nozzle or faucet which illuminates a column of water produced by the nozzle or faucet.

It is still a further feature of the present invention to provide a nozzle or faucet in which the color of the light illuminating the water column may be changed.

Another feature of the present invention is to provide a water nozzle or faucet which may change the color of the light illuminating the water column to indicate a change in condition.

Yet another feature of the present invention is to provide an appliance, such as a household refrigerator, which includes a water dispensing feature wherein the water dispenser illuminates the column of water dispensed.

A further feature of the present invention is to provide an appliance, such as a household refrigerator, which includes a water dispensing feature wherein the water dispenser illuminates the column of water to be dispensed and may change the color of the column of water to be dispensed.

A further feature of the present invention is to provide an appliance, such as a household refrigerator, which includes a water dispensing feature wherein the water dispenser illuminates the column of water to be dispensed and may change the color of the column of water to be dispensed to indicate a change in condition.

One or more of these and/or other objects, features or advantages of the present invention will become apparent from the specification and claims that follow.

According to one aspect of the present invention, a water dispenser is provided. In one embodiment, the water dispenser is provided as a household faucet. This household faucet includes a nozzle which is in fluid communication with a water supply line. When operated, the nozzle dispenses a column of water. The faucet also includes a light source which is secured within the faucet to illuminate the column of water when dispensed. The light source may be turned on at any time, with or without the water running, to indicate where the water faucet is pointed. Preferably, the light source is located within the faucet so as to shine within the water stream that results in the water column. The light source secured within the faucet is preferably able to change the color of the light emitted.

A controller or processor is also preferably connected to the light source. The controller or processor indicates when the light source should be operated. Operation of the light source is preferably done only when the faucet is dispensing water, but may be done at any time. The controller or processor may also dictate what color of light is emitted from the light source. This color choice may be selected by the consumer based on the consumer's preference or may be selected by the processor to indicate a change in condition of the faucet or associated systems. This change in condition can be relayed to the processor or controller through one or more sensors.

Another embodiment of the present invention includes a typical household refrigerator with a built-in water dispenser. A refrigerator cabinet including a door secured to the cabinet is provided. A dispensing unit may be secured either to the door or to the interior of the refrigerator cabinet. The dispenser unit includes a water supply line, a nozzle in fluid communication with the water supply line and a light source secured within the dispenser. When the nozzle dispenses a column of water, the light source secured within the dispenser unit illuminates the column of water. This household appliance may also include a light source that changes color.

A processor is preferably connected to the light source and the dispenser unit. When the dispenser unit is activated, the processor tells the light source to turn on. Alternatively, the light source may be operated at any time to tell the consumer where to place their glass within the dispenser unit. The processor may also tell the light source to change color. The change in color may be dictated by either the consumer's preference or by a change in condition. For example, when the temperature of the water changes from hot to cold, the processor can control the color of the water column by changing the color of the light source from red to blue. Thus, the change in color indicates the temperature of the water has changed. Other conditions such as the water filter status may also be monitored.

According to another aspect of the present invention, a method for illuminating a column of water is provided. The method includes running water through a water dispenser including a nozzle. A column of water is formed and a light source in the water dispenser shines into the column of water. By shining the light source into the column of water, the column of water is illuminated. The method may further include changing the color of the illuminated column of water. The change in color of the illuminated column of water can be done to indicate either the consumer's preference or a change in condition.

### BRIEF DESCRIPTION OF THE DRAWINGS

FIG. 1 is front view of an exemplary refrigerator according to one embodiment of the present invention.

FIG. 2 is a block diagram showing fluid connections in a typical household refrigerator.

FIG. 3 is a cross sectional view of a water dispenser associated with a household refrigerator according to one embodiment of the present invention wherein the water dispenser is shown in the off position.

FIG. 4 is a cross sectional view of a water dispenser associated with a household refrigerator according to one embodiment of the present invention wherein the water dispenser is shown in the on position.

FIG. 5 is a block diagram of electrical connections according to one embodiment of the present invention.

FIG. 6 is a perspective view of a faucet according to one embodiment of the present invention.

FIG. 7 is a cross-sectional view of a faucet according to one embodiment of the present invention.

### DETAILED DESCRIPTION OF THE PREFERRED EMBODIMENT

The present invention will now be described as it applies to its preferred embodiment. It is not intended that the present invention be limited to the described invention. It is intended that the invention cover all modifications and alternatives which may be included within the spirit and scope of the invention.

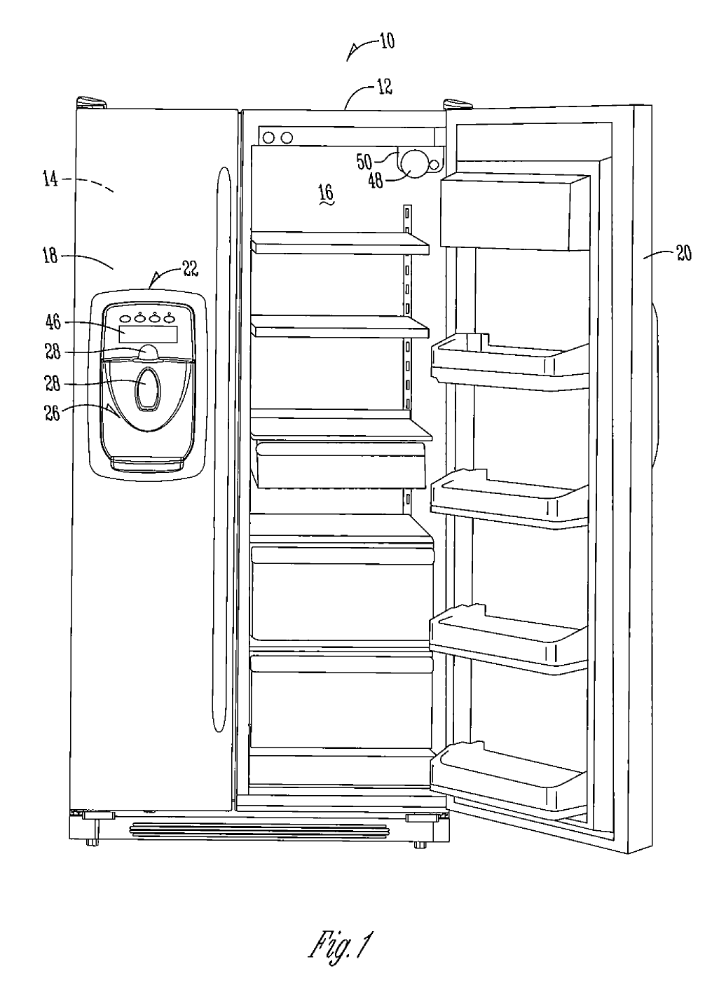

Now, referring to the drawings, FIG. 1 illustrates a typical household refrigerator 10. The household refrigerator is shown in a side by side arrangement. This means that the refrigerator compartment 16 is on one side of the refrigerator and the freezer compartment 14 is on the other side of the refrigerator. Other layouts of the freezer compartment 14 and refrigeration compartment 16 may be used. For example, the freezer compartment 14 may be located on the bottom of the cabinet 12 while the refrigeration compartment 16 is located within the upper portion of the cabinet 12. Alternatively, the refrigerator 10 may consist entirely of one or more refrigerator compartments. The refrigerator 10 may also consist entirely of one or more freezer compartments. Any arrangement is acceptable for the present invention.

As shown in FIG. 1, a refrigerator 10 includes a refrigerator compartment door 20 and freezer compartment door 18, which are secured to the refrigerator cabinet 12. Typically, an ice and water dispenser unit 22 is included within the freezer compartment door 18. This is typically done by mounting the dispenser housing 26 on the upper half portion of the freezer compartment door 18. Alternatively, the ice and water dispenser unit 22 may be located within the refrigerator compartment door 20. If only a water dispenser unit is employed, the water dispenser unit may be located within the cabinet 12. A water filter 48 is typically located in a water filter housing 50 which is mounted in a convenient location.

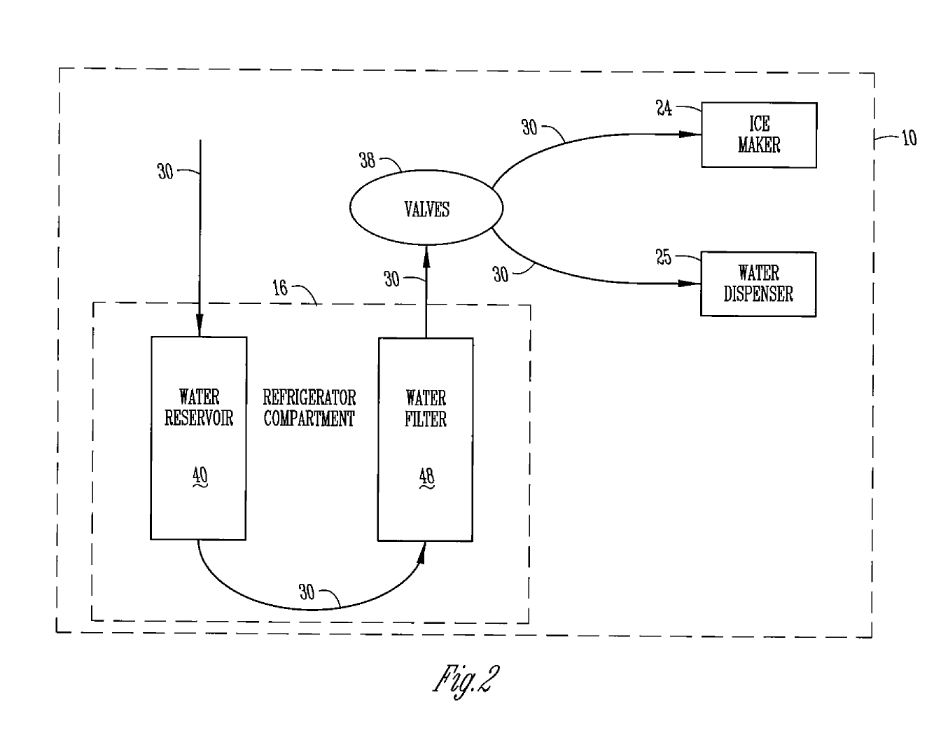

As shown in FIG. 2, water is provided to the ice/water dispenser unit 22 through a water supply line 30. The water supply line 30 preferably sends water to an internal water reservoir 40 that may be located within the refrigerator compartment 16 or in any other desired location within the cabinet 12. Within the water reservoir 40, the water may be chilled or heated, depending on the desired use. Preferably, a water filter 48 is also included. The water filter 48 may be located anywhere within the water fluid circuit so long as water is filtered prior to dispensing. For example, the water filter 48 may be located before the water reservoir 40 so that filtered water is stored in the water reservoir 40.

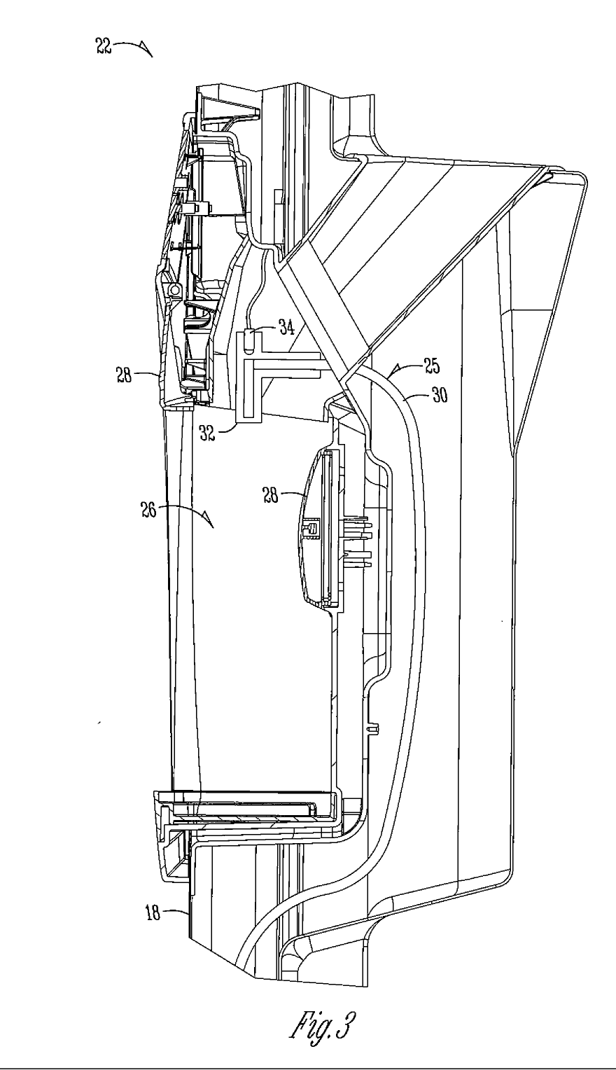

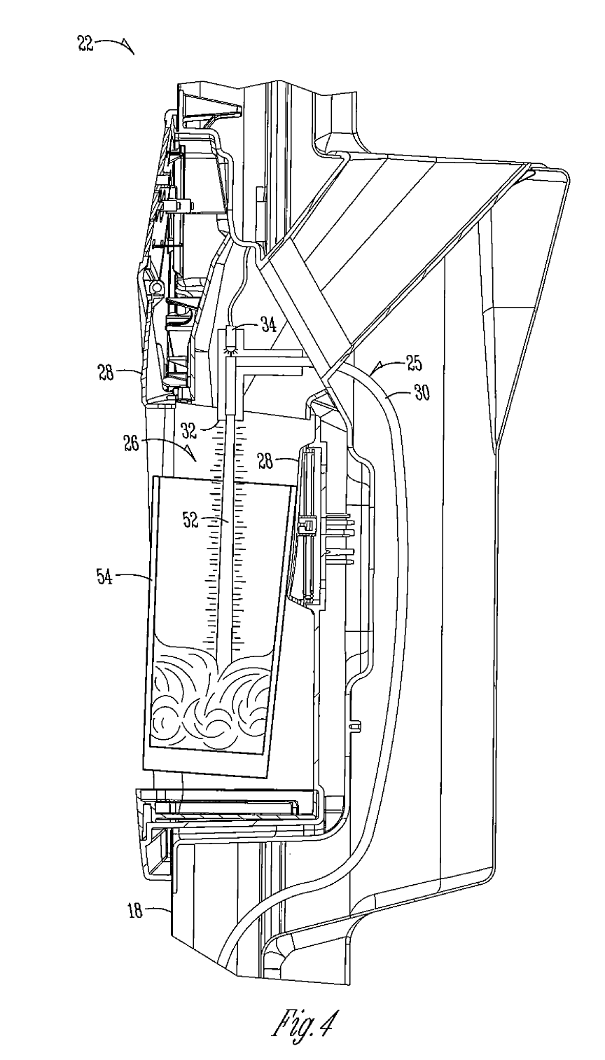

As shown in FIG. 2, unfiltered water is stored in the water reservoir 40. This unfiltered water then travels through the water filter 48 until it reaches the water valves 38 that control when and where the water dispensed. If an ice maker 24 is included, dual valves 38 may be employed to provide water to the ice maker 24 and also to a water dispenser 25 when necessary. The water dispenser 25 is shown in more detail in FIGS. 3 and 4.

As shown in FIGS. 3 and 4, the dispenser unit 22 includes a dispenser housing 26 that defines a well or cavity into which the consumer places a glass 54. An actuator or button 28 is typically provided on the interior of the well to allow a consumer to activate the system by pushing their glass against the actuator 28. Alternatively, and as shown, actuators 28 may be located both on the interior of the well and on the outer surface of the dispenser housing 26. The actuator 26 turns the system on and a nozzle 32 provides a water column that is directed into the consumer's glass 54. Such a water dispenser provides a convenient way for consumers to obtain chilled water quickly.

For example, water from the water reservoir 40 may be chilled within the refrigerator compartment 16. When the consumer places a glass 54 into the dispenser unit 22 and activates the button 28, the processor or controller 36 is sent a signal. Operation of the button 28, which may be a mechanical or electrical switch or another type of sensor, typically completes an electrical circuit between a source of power and a solenoid operated valve 38 connected to the water supply or water reservoir 40. When the solenoid valve 38 is opened, pressure in the water reservoir 40 forces water through the water supply line 30 and into the nozzle or spout 32. After traveling to the nozzle 32, the water is dispensed as a column 52 of water into the consumer's glass 54.

Preferably, a light source 34 is also located within the ice/water dispenser unit 22. The light source 32 is placed within the water dispenser in a manner such that it illuminates the column of water produced by the dispenser nozzle 32. For example, the light source 32 is placed to shine light in the direction of flow of the column of water. The use of a mirror or other path altering device such as a prism or lens is acceptable. Alternatively, the body of the dispenser nozzle 32 may be made of a transparent or semi-transparent material, such as clear plastic or glass, to allow for some of the light produced by the light source 34 to shine through the dispenser nozzle 32.

Preferably, the light source is a super bright light emitting diode “LED”. Other possible light sources include an organic light-emitting diode “OLED,” a polymer light-emitting diode “PLED,” an incandescent light source, a laser light source, a xenon light source, a halogen light source, an electroluminescence panel, or any type of solid state illumination device. An LED typically consumes less energy then some other types of light sources. LEDs also come in multiple colors or color changing varieties.

The light source 34 is preferably located within the nozzle 32 to shine within the water stream that produces the water column 52. Alternatively, the light source 34 may also be located outside of the water stream that produces the water column 52 so long as it shines on the column. The water column 52 is produced by allowing the water to flow under pressure in a state of free fall. The light produced by the light source 34 reflects off of the water/air interface causing the light to be partially reflected back into the water column 52. In this manner, the water column 52 acts as a light pipe and it appears as if the light is coming from the water column 52.

Any color of light can be used. An additional feature of the preferred embodiment allows the consumer to select the color of their desired water column 52. The selection of the color of the water column 52 can be made by the consumer providing their preference by making a selection on the display 46. The display 46 is preferably a touchscreen display. Alternatively, the display 46 may be a screen that presents options next to buttons external to the display 52. Once the consumer has made their selection, the choice is sent to the processor or controller 36. The processor 36 uses the consumer's input to determine which color of light to have the light source 34 provide.

In the example of an LED light source 34, the processor 36 sends a signal to a driver or micro controller (which may be incorporated as part of the overall processor or controller 36). The driver may control a number of individually colored LEDs or a bi-color or multi-color LED. Alternatively, the color may be changed by shining the light through a colored lens or other colored and transparent material such as a color wheel. When the signal is received, the desired color is produced.

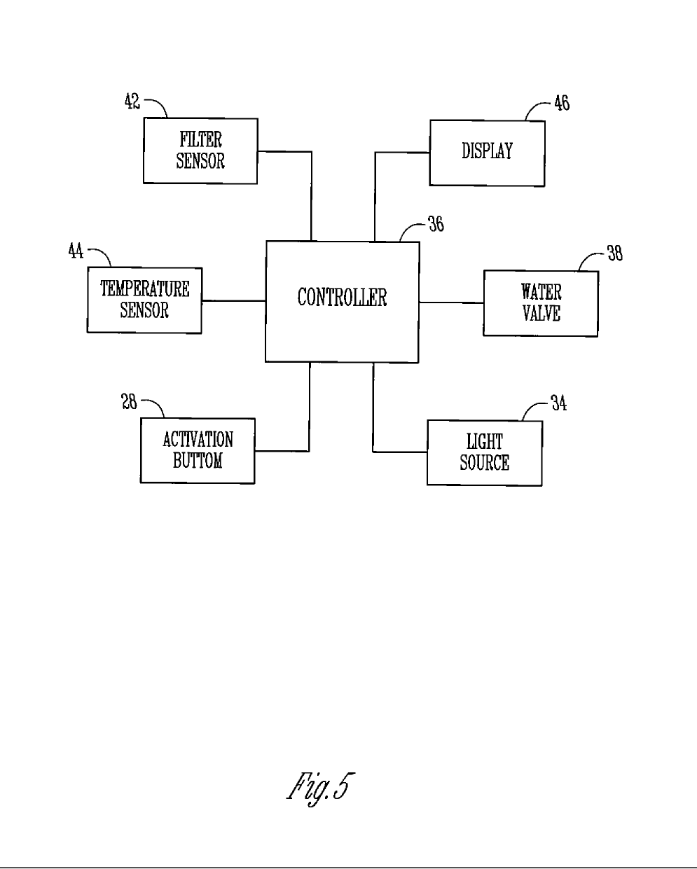

Alternatively, the color of the light source 34 may be changed to indicate something other than the consumer's preference. For example, the color of the light source 34 may be changed to indicate a change in a condition. In the refrigerator water and ice dispenser, the change in condition can be that a sensor indicates it is time to change the water filter. Many refrigerators include a filter sensor 42 as shown in FIG. 5. The filter sensor 42 may be a timer or flow rate sensor that provides an indication of the filter's use to the processor 36. If the filter use has exceeded the set criteria, the processor 36 can send a signal to the driver and change the color of the light source 34.

Similarly, the color of the light source 34 can change to indicate a leak in the overall system. Moisture sensors alert the processor when moisture is detected. In this manner leaks can be detected before they have filled a portion of the refrigerator cabinet 12 and progressed onto the floor of the consumer's home. For example, if the moisture sensor (not shown) detects a leak, it sends a signal to the processor 36 which sends a signal to the driver to change the color of the light source 34 from white to red, alerting the consumer to a problem with the system.

Alternatively, the light source 34 can also indicate the temperature of the water being dispensed. For example, when a temperature sensor 44 is included in the system and a hot water reservoir is included, the color of the light source 34 can be set to red to indicate hot water is being dispensed. When cold water is being dispensed, the color of the light source 34 can be set to blue. These color settings are merely exemplary.

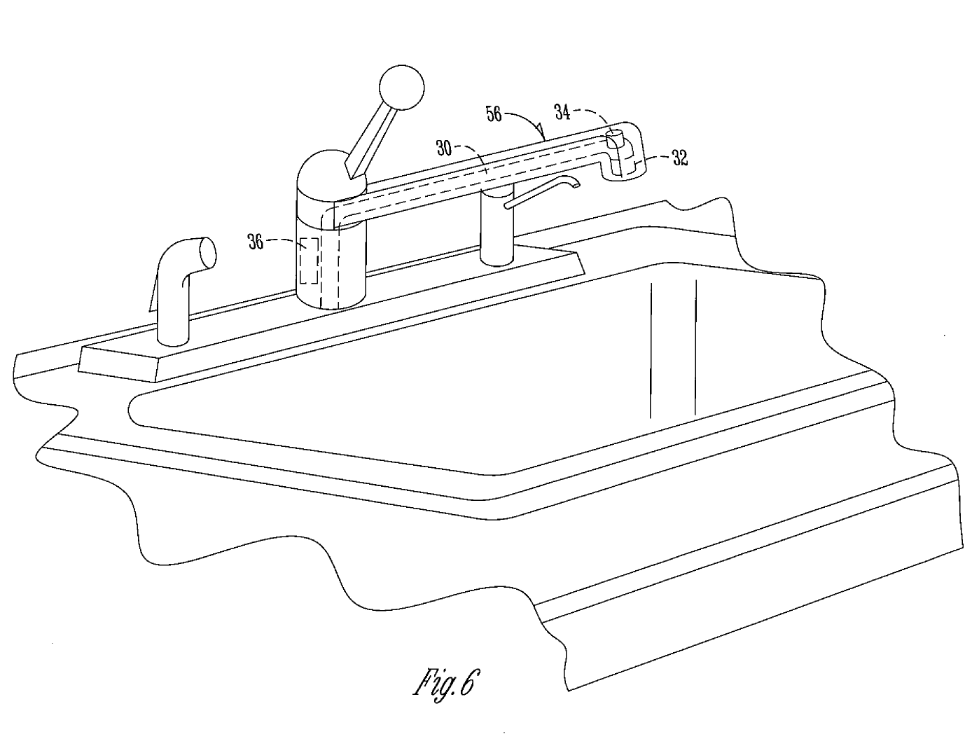

FIG. 6 shows another embodiment of the present invention. As shown, a faucet 56 is provided with a water supply line 30, a nozzle 32, a light source 34 and a processor or controller 36. Power is supplied to the faucet 56 through either a plug-in cord arrangement or through a battery (not shown). As previously indicated, the light source 34 operates at least when the faucet 56 is dispensing water and illuminates the column of water 52 produced by the nozzle 32. The light source 34 may change color as previously discussed.

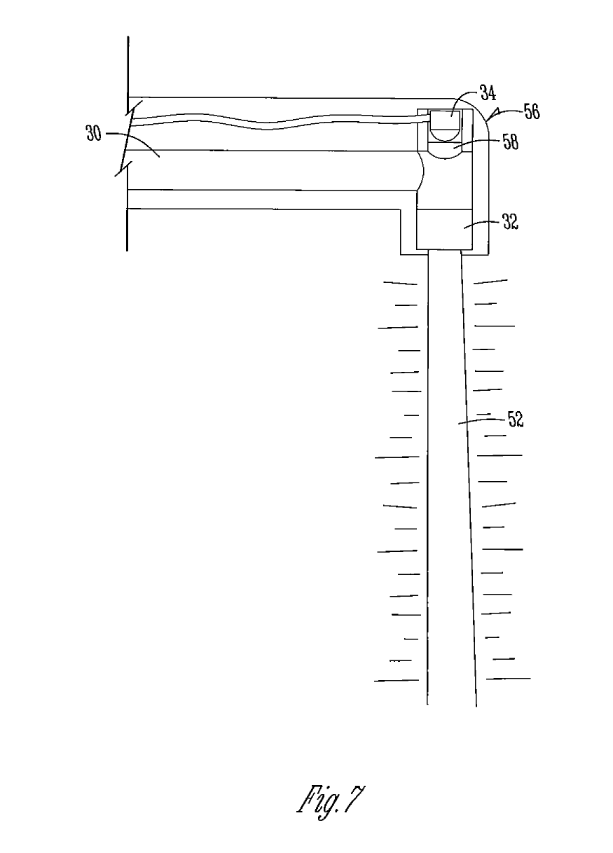

FIG. 7 shows a cross-sectional view of the faucet 56 discussed above. Preferably, the light source 34 is a 3 mm LED. The nozzle 32 and/or the faucet 56 may be clear or semi-transparent. This allows the faucet 56 to appear to glow when in operation, thus improving the chances that consumers will not inadvertently leave the water running. As shown in FIG. 7, a lens may be used in between the light source 34 and the column of water 52 produced by the nozzle 32. The lens 58 may be plastic, glass or any other type of transparent or semi-transparent material. The lens 58 may be colored or clear. The lens 58 may be concave, convex or without any curvature and may be formed as a separate piece or integrally with one or more parts of the faucet 56. The curvature of the lens 58 will depend on the area in which the light is desired. Preferably, the lens 58 focuses the light from the light source 34 to project a 1-inch diameter spot onto a surface 10 inches from the light source 34.

When the water is not running in either the faucet 56 or the ice/water dispenser unit 22, the light source 34 may still be turned on. This will cause the light source 34 to shine light into an area where water would flow. For example, the context of the ice/water dispenser unit 22, the light source 34 would shine light into a spot within the ice/water dispenser unit 22 to indicate to the consumer where the glass should be placed prior to turning on the water.

A general description of the present invention as well as a preferred embodiment of the present invention has been set forth above. Those skilled in the art to which the present invention pertains will recognize and be able to practice additional variations in the methods and systems described which fall within the teachings of this invention. Accordingly, all such modifications and additions are deemed to be within the scope of the invention which is to be limited only by the patent claims.

What is claimed is:

1. A refrigerator including a dispenser, the refrigerator comprising:
a refrigerator cabinet;
a door secured to the cabinet;
a dispenser unit secured to the door, the dispenser unit including a water supply line, a nozzle in fluid communication with the water supply line where the nozzle dispenses a column of water, and a light source secured within the dispenser unit to illuminate the column of water.

2. The refrigerator of claim 1 wherein the light source is operated only while the column of water is dispensed.

3. The refrigerator of claim 1 wherein the light source is operated while the column of water is not being dispensed.

4. The refrigerator of claim 1 wherein the light source is secured within the dispenser changes colors.

5. The refrigerator of claim 4 wherein the light source includes an incandescent light bulb and a plurality of colored lenses.

6. The refrigerator of claim 1 wherein the light source is one or more LEDs.

7. The refrigerator of claim 1 wherein the nozzle is transparent.

8. The refrigerator of claim 1 wherein the nozzle is semi-transparent.

9. The refrigerator of claim 1 wherein the refrigerator further includes a processor operatively connected to the light source.

10. The refrigerator of claim 9 wherein the light source secured within the dispenser changes colors and the change in color is controlled by the processor.

11. The refrigerator of claim 9 wherein the refrigerator includes a sensor operatively connected to the processor.

12. A water dispenser for illuminating a column of water, the dispenser comprising:
a water supply line;
a nozzle in fluid communication with the water supply line for dispensing a column of water; and
a light source secured within the dispenser to illuminate the column of water.

13. The water dispenser for illuminating a column of water of claim 12 wherein the water dispenser is part of a household water faucet.

14. The water dispenser for illuminating a column of water of claim 12 wherein the water dispenser is included in a household refrigerator.

15. The water dispenser for illuminating a column of water of claim 12 wherein the nozzle is transparent.

16. The water dispenser for illuminating a column of water of claim 12 wherein the nozzle is semi-transparent.

17. The water dispenser for illuminating a column of water of claim 12 wherein the light source secured within the dispenser is a color changing light source.

18. The water dispenser for illuminating a column of water of claim 12 wherein the refrigerator further includes a processor operatively connected to the light source.

19. The water dispenser for illuminating a column of water of claim 18 wherein the light source secured within the dispenser is a color changing light source and is controlled by the processor.

20. The water dispenser for illuminating a column of water of claim 18 wherein a sensor is operatively connected to the processor.

21. The water dispenser for illuminating a column of water of claim 20 wherein the sensor is a thermocouple.

22. The water dispenser for illuminating a column of water of claim 20 wherein the sensor is a moisture sensor.

23. A method of dispensing water from a refrigeration unit, the method comprising:
providing a water dispenser having a water supply line, a nozzle in fluid communication with the water supply line and a light source within the dispenser to illuminate a column of water;
forming the column of water; and
illuminating the light source to shine into the column of water.

24. The method of dispensing water of claim 23 wherein the light source is illuminated with a first color to indicate normal operation and a second color to indicate a change in a condition.

25. The method of dispensing water of claim 24 wherein the second color indicates a water filter should be replaced.

26. The method of dispensing of claim 24 wherein the second color indicates a leak has occurred.

27. The method of dispensing of claim 23 wherein the light source is illuminated with a first color to indicate cold water and a second color to indicate hot water.
